(19) United States
(12) Patent Application Publication
(10) Pub. No.: US 2006/0145540 A1
(43) Pub. Date: Jul. 6, 2006

(54) Dual linear control footswitch

(76) Inventor: Victor B. Mezhinsky, Brea, CA (US)

Correspondence Address: Alan R. Thiele;Strasburger & Price, LLP, 901 Main St., Suite 4400, Dallas, TX, 75202, US

(21) Appl. No.: 11/235,448

(22) Filed: Sep. 26, 2005

Related U.S. Application Data
(60) Provisional application No. 60/627,342, filed on Nov. 12, 2004.

(51) Int. Cl. H01H 35/00

(52) U.S. Cl. 307/119

(57) ABSTRACT

A footswitch with a tiltable treadle for a first linear control input enables a second linear control input by use of a radial slider assembly positioned on top of the pedal treadle. Movement of the radial slider assembly provides a second linear control input to a potentiometer.

This application claims priority from Provisional U.S. Patent Application No. 60/627,342, filed Nov. 12, 2004.

### FIELD

The present invention pertains to a footswitch by which an operator provides force inputs affecting the operation of an electromechanical device; more particularly, the present invention pertains to a footswitch providing the operator with the capability to effect two force inputs to two distinct linear controls.

### BACKGROUND

While footswitches are used with a variety of different types of electromechanical equipment, footswitches have gained wide acceptance and have become an accepted part of the operator controls which enable the use of microsurgical and ophthalmic systems. Accordingly, the present footswitch invention will be described in terms of its use with microsurgical and ophthalmic systems.

Most footswitches, such as those commonly found on microsurgical or ophthalmic systems, have a single linear input. This single input is effected by a tiltable treadle similar to the accelerator pedal which regulates the flow of fuel to the engine in an automobile.

On a microsurgical or ophthalmic system, a function such as vacuum is regulated in a linear manner by changing the pitch of a tiltable treadle using force applied by the operator's foot. Because of the complexity of microsurgical or ophthalmic operations, it is desirable to provide a second linear input for another distinct function, such as ultrasound power or laser light intensity. And, because of the sensitivity of control inputs during microsurgical operations, it is desirable that all control inputs effected by a footswitch be mechanically and electrically separate from one another.

Examples of footswitches may be found in the following references.
U.S. Pat. No. 4,837,857 Scheller, et al.
U.S. Pat. No. 4,965,417 Massie
U.S. Pat. No. 4,983,901 Lehmer
U.S. Pat. No. 5,091,656 Gahn
U.S. Pat. No. 5,268,624 Zanger
U.S. Pat. No. 5,554,894 Sepielli
U.S. Pat. No. 5,580,347 Riemels
U.S. Pat. No. 5,635,777 Telymonde, et al.
U.S. Pat. No. 5,787,760 Thoralakson
U.S. Pat. No. 5,983,749 Holtorf
U.S. Pat. No. 6,179,829B1 Bisch, et al.
U.S. Pat. No. 6,639,332 Metzler, et al.
WO 98/08442 Bisch, et al.
WO 00/12037 Chen
WO 02/01310 Chen

### SUMMARY

The present invention describes a footswitch which enables two distinct linear control inputs in response to forces imparted to the footswitch by two distinct movements of the operator's foot. The systems within the footswitch for receiving and acting upon the two linear control inputs are maintained mechanically and electrically separate from one another.

The tiltable treadle is mounted and configured to enable a change in pitch. The pitch movement of the tiltable treadle provides a first linear input, typically to a motor and encoder, to control an operating parameter such as vacuum or air pressure. The pitch angle of the tiltable treadle proportionally regulates the amount of the operating parameter. In other applications, the tiltable treadle can provide fixed control of an operating parameter so that any depression or downward change in the pitch of the tiltable treadle away from the full up or top position will result in a fixed or predetermined array of one or more outputs to regulate an operational parameter.

Located on top of the tiltable treadle is a radial slider. The radial slider is in physical contact with the top of the tiltable treadle using anti-friction elements such as ball bearings. These anti-friction elements enable a substantially arcuate or yaw movement of the radial slider with respect to the tiltable treadle. Thus, when the operator pivots the front of his/her foot to the left or to the right, in a radial motion, while the operator's heel remains in a substantially stationary location, the radial slider is caused to move along a substantially arcuate or yaw path. The radial slider is that portion of a larger assembly that is in contact with the bottom of the operator's foot.

Beneath the radial slider and under the tiltable treadle is an angular motion transfer mechanism. Movement of the radial slider causes movement of the angular motion transfer mechanism. This angular motion transfer mechanism transforms the substantially arcuate or yaw movement of the radial slider into a rotational movement. This rotational movement is imparted to a shaft. The shaft is connected to a potentiometer assembly. The position of the potentiometer in response to the rotation of the shaft governs the level of an electrical signal. The electrical signal is then used to control a second operational parameter of the equipment to which the footswitch is attached.

### BRIEF DESCRIPTION OF DRAWING FIGURES

A better understanding of the footswitch of the present invention may be had by reference to the drawing figures, wherein:

FIG. 1 is a perspective view of the footswitch of the of the present invention;

FIG. 2 is right side elevation view of the footswitch in partial cross-section;

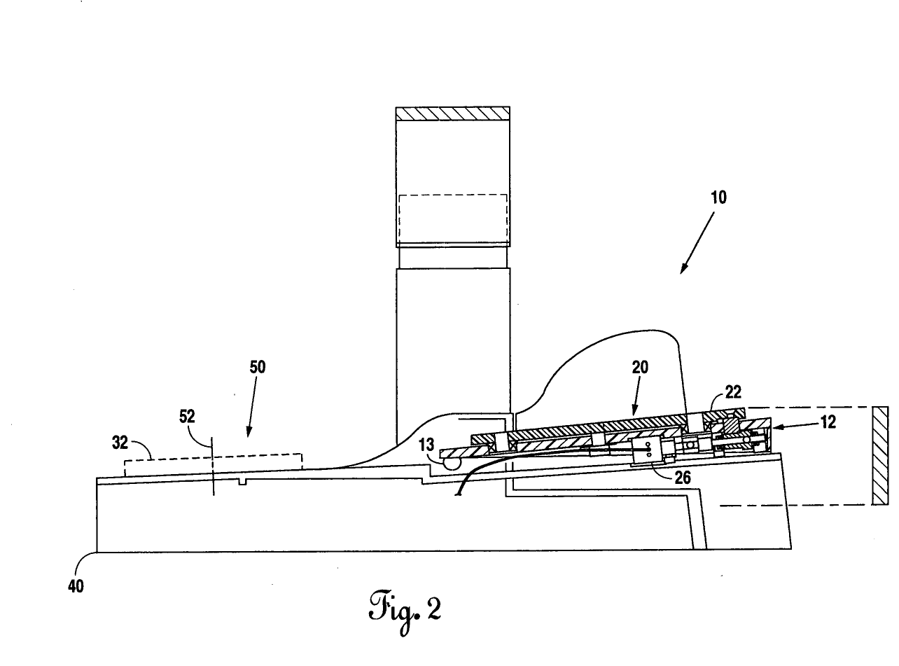

FIG. 3 is a top plan view of the footswitch; and

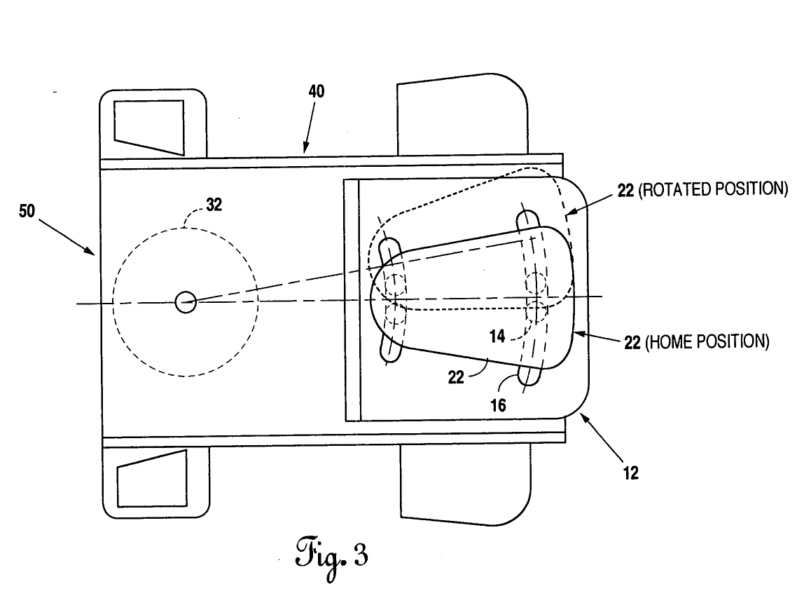

FIG. 4 is an enlarged cross-sectional view of the radial slider assembly of the footswitch.

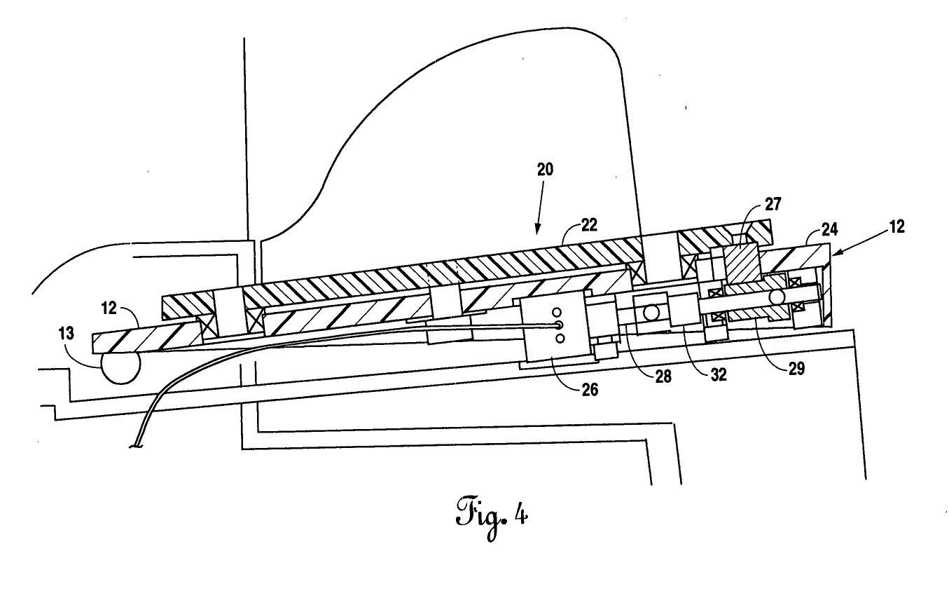

### DESCRIPTION OF THE EMBODIMENTS

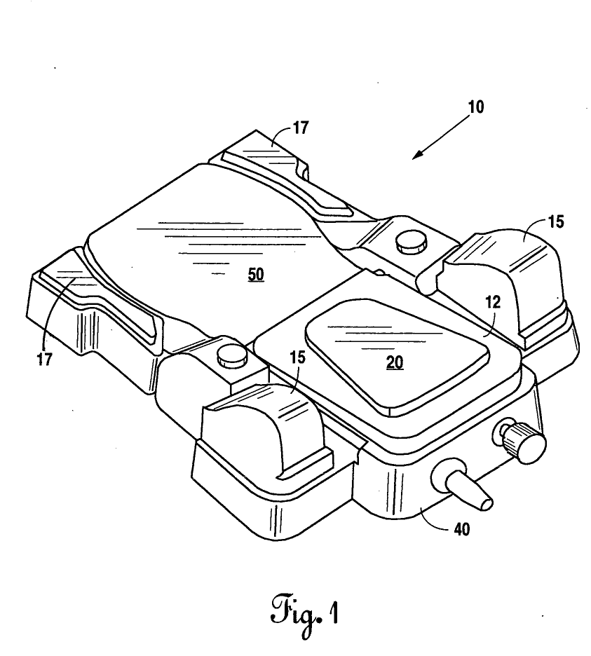

Operational input to a microsurgical or ophthalmic system is typically provided by the footswitch assembly 10 of the present invention. As shown in FIG. 1, the footswitch assembly 10 consists of a tiltable treadle 12, right and left side switches 15, and right and left heel switches 17. The switches 15 and 17 are typically located on both sides of the tiltable treadle 12 and/or the heel area 50.

Generally, the tiltable treadle 12 that is kinematically connected to a motor and encoder (not shown) provides a single linear proportional control of a frequently used system operational parameter such as vacuum. The angle of depression or pitch angle of the tiltable treadle 12 is proportional to the parameter output. In certain modes of operation, the tiltable treadle 12 is configured to provide a fixed control of an operational parameter wherein any depression beyond the full up position results in a fixed or predetermined array or one or more outputs to regulate the operational parameter. An internal spring (not shown) returns treadle 12 to a home or neutral position as soon as the foot is lifted off treadle 12.

Construction

The major components of the disclosed footswitch, as shown in the drawing figures, are the housing/base 40, the tiltable treadle 12, the tiltable treadle support shaft 13, the heel pad/plate 32, the radial slider assembly 20, and the open loop feedback device 26 (for the second linear control).

The footswitch 10 of the present invention includes an additional separate linear proportional control of a system operational parameter. This additional separate linear proportional control is provided by a radial slider assembly 20. A portion of the radial slider assembly 20, specifically, the radial slider 22, is placed on top of the treadle pedal 12 for contact with the bottom of the operator's foot. The bottom of the radial slider 22 engages the top of the treadle pedal 12 using anti-friction elements 14, such as keys or bearings that protrude though one or more slots 16 in the tiltable treadle 12. The one or more slots 16 may be straight or arcuately shaped to act as a motion guide and to enable the radial slider 22 of the radial slider assembly 20, which engages the operator's foot, to be moved toward either side of the footswitch 10 from its neutral (home) position. There is a “Lazy Susan”-like pad 32 in the footswitch heel area 50 that facilitates the angular/yaw movement of the operator's foot.

To effect the second linear proportional control, the operator places the heel portion of the foot onto the “Lazy Susan”-like pad 32, and the ball of the foot is placed onto the radial slider 22 of the radial slider assembly 20. Then, the operator moves his/her foot toward the side of the footswitch 10 in an angular/yaw fashion. This angular/yaw movement of the operator's foot enables an angular/yaw movement of the radial slider 22 of the radial slider assembly 20. The position of the tiltable treadle 12 remains stationary, even when the tiltable treadle 12 is depressed. Accordingly, the radial/yaw movement of the operator's foot is kept separate and apart from the pitch movement of the operator's foot. The radial slider assembly 20 is engaged with an open loop feedback device 26, such as an encoder or potentiometer, by means of geared rack-and-pinion system or, alternatively, a frictionally operated system 24. The linear or angular movement of the radial slider 22 of the radial slider assembly 20 is converted into an angular rotation motion of the open loop feedback device 26. The open loop feedback device 26 is located in the footswitch base 40.

Operation

The first linear control is accomplished by the tiltable treadle 12 portion of the footswitch 10, whose mounting enables vertical or pitch movement about a shaft/axis in the base.

The second linear control is accomplished by a simple mechanism, driven by the operator's foot, which enables radial movement of the radial slider 22 of the radial slider assembly 20 in an angular/yaw fashion about the heel pad 52 axis from its neutral position to either side of the footswitch 10. The use of a radial slider assembly 20 whose movement is effected by a radial slider 22 on top of the treadle pedal 12 improves the ergonomics of the footswitch, simplifies construction, reduces cost, and enables use of commonly available components.

The second linear control responds to the movement of the operator's foot in an angular/yaw fashion. The friction force between the bottom surface of the operator's foot and the top surface of the radial slider 22 produces movement of the radial slider 22 to the side of the footswitch 10 along a substantially arcuate or yaw guide path. The friction force between the radial slider 22 and the top of the treadle pedal 12 is significantly lower than the friction force between the operator's foot and the radial slider 22 due to the presence of the ball bearings 14. The ball bearings 14 are inserted into one or more slots 16 in the tiltable treadle 12 and are attached to the bottom surface of the radial slider 22.

The angular/yaw movement of the radial slider 22 generates the rotation of the potentiometer 26 shaft 28 via the angular motion transfer mechanism 24. This angular motion transfer mechanism 24 converts the angular motion of the radial slider 22 into a rotational motion of the shaft 28. The angular motion transfer mechanism 24 consists of a straight or arc-shaped rack or friction bar 27. The friction bar 27 is engaged with a pinion or friction wheel 29. A first shaft 32 supports the pinion or friction wheel 29 and is connected to a second shaft 28, which is connected to the potentiometer 26. An internal spring (not shown) returns the radial slider 22 to its home position as soon as the foot is lifted off the radial slider 22. The rotation of the second shaft 28 results in a proportional electronic output signal that is used to control the operation of a system parameter.

By having two systems for accepting a linear proportional control input from an operator's foot, the time needed to control multiple operating parameters is minimized by simultaneous control of system parameters such as flow or vacuum, ultrasound power, or laser light intensity, etc.

What is claimed is:

1. A footswitch assembly for providing two linear control inputs to an electromechanical device in response to forces exerted by an operator's foot, said footswitch assembly comprising:
a housing, said housing including an area constructed and arranged to support the heel of an operator;
a tiltable treadle pivotably mounted in said housing for engagement with the bottom of an operator's foot, said pivotable mounting enabling changing the pitch movement of said tiltable treadle, said tiltable treadle being connected to a first electromechanical system for providing an electrical signal representative of the pitch movement of said tiltable treadle;
a radial slider assembly mounted on said tiltable treadle for engagement with the bottom of an operator's foot, said mounting of said radial slider assembly enabling yaw movement of said radial slider assembly, said radial slider assembly being connected to a second electromechanical system for providing an electrical signal representative of the yaw movement of said radial slider assembly; and
wherein said first and second electromechanical system are mechanically and electrically independent of one another.

2. The footswitch assembly as defined in claim 1 wherein said yaw movement of said radial slider assembly is accomplished by pivotal movement of the front of the operator's foot.

3. The footswitch assembly as defined in claim 1 wherein pitch movement of said tiltable treadle and yaw movement of said radial slider assembly may be accomplished independently of one another.

4. The footswitch assembly as defined in claim 1 wherein said tiltable treadle will return to a predetermined position when force from the operator's foot is taken away.

5. The footswitch assembly as defined in claim 1 wherein said radial slider assembly will return to a predetermined position when force from the operator's foot is taken away.

6. The footswitch assembly as defined in claim 1 wherein said yaw movement of said radial slider assembly effects rotation of a shaft.

7. The footswitch assembly as defined in claim 6 wherein said shaft is connected to a feedback device, said feedback device providing an electrical signal indicative of the rotary position of said shaft.

8. The footswitch assembly as defined in claim 6 wherein rotation of said shaft is effected by friction engagement within an angular motion transfer mechanism.

9. The footswitch assembly as defined in claim 6 wherein rotation of said shaft is effected by a gear engagement within an angular motion transfer mechanism.
